(19) United States
(12) Patent Application Publication
(10) Pub. No.: US 2014/0304915 A1
(43) Pub. Date: Oct. 16, 2014

(54) Occupant Support Adapted to Manage Pressure Ulcer Risk and Associated Risk Management Methods

(71) Applicant: Charles A. Lachenbruch, Lakeway, TX (US)

(72) Inventor: Charles A. Lachenbruch, Lakeway, TX (US)

(21) Appl. No.: 13/866,249

(22) Filed: Apr. 19, 2013

Related U.S. Application Data
(60) Provisional application No. 61/810,847, filed on Apr. 11, 2013.

(51) Int. Cl. A61G 7/057

(52) U.S. Cl. CPC A61G 7/0573
USPC 5/600

(57) ABSTRACT

A method of accommodating pressure ulcer vulnerability of an occupant of an occupant support, a method of managing pressure ulcer risk of an occupant of an occupant support, and an occupant support adapted to manage pressure ulcer risk of an occupant thereof are disclosed. The methods and occupant support account for occupant specific or occupant class specific risk factors based on empirical data.

### TECHNICAL FIELD

This application describes an occupant support adapted to manage the risk that an occupant of the occupant support will develop pressure ulcers, a method of managing pressure ulcer risk, and a method of accommodating pressure ulcer vulnerability of such an occupant.

### BACKGROUND

Individuals who are confined to an occupant support such as a wheelchair or hospital bed are at risk of developing pressure ulcers. Various aides are available to assist clinicians and other caregivers in assessing a patient's risk of developing pressure ulcers. One of these is the Braden score or Braden scale which assesses risk based on several risk factors. These factors include the patient's sensory perception (ability to respond meaningfully to pressure related discomfort), the degree to which the patient's skin is exposed to moisture, the degree of physical activity that the patient is capable of, the patient's ability to change and control his or her body position, the patient's food intake pattern, and the extent to which the patient's condition exposes his or her skin to friction and shear. Although the Braden score is useful, it is a subjective assessment.

One other aide is the well known Reswick and Rogers (herinafter R&R) empirically based pressure-time curve. The R&R curve is a graph of pressure p as a function of time t. When pressure is expressed in millimeters of mercury (mm Hg) and time is expressed in hours the coordinates of the R&R curve are given by the following equation:

p·t=300 mm Hg-hr (1)

The curve defines an approximate “50/50” boundary, i.e. a patient whose skin is subjected to a pressure-time combination whose product exceeds 300 mm Hg-hr has a greater than approximately 50% probability of developing a pressure ulcer whereas a patient whose skin is subjected to a pressure-time combination whose product is less than or equal to 300 mm Hg-hr has no more than approximately a 50% probability of developing a pressure ulcer. Although the R&R curve is widely known, its validity for very long or very short periods of time has been called into question. For example for patients undergoing complicated surgeries and who are immobilized on an operating table for 12 hours or more, the R&R curve predicts a higher prevalence of pressure ulcer development than is borne out by actual experience. At the short duration end of the time scale, e.g. five minutes, the R&R curve predicts that a patient should be able to tolerate pressures that are known to be high enough to cause significant harm.

Moreover, the R&R curve, despite being less subjective than the Braden score, does not account for risk factors that are patient specific or patient class specific (specific to some defined class of patients).

As a practical matter, methods and devices for real-time mitigation of pressure ulcer risk will rely on measurements of skin pressure, i.e the pressure exerted on the patient's skin (also referred to as “interface pressure”). However of the tissues affected by pressure—skin, fat, fascia, tendon and muscle—muscle is the most vulnerable to injury by deformation or ischemia, thus its tolerance sets the limit for tissue breakdown. In addition, the pressure experienced by a patient's muscle tissue is not the same as the skin pressure. Among the reasons for this difference are that the collagen network in the skin supports some of the external load and prevents it from being transmitted inwardly to the muscle, and that the shapes of boney prominences affect the magnitude of the loading actually applied to the muscle.

Accordingly, it is desirable to develop occupant supports and associated methods of managing pressure ulcer risk and accommodating pressure ulcer vulnerability of a patient that are less subjective than Braden score, are more accurate than the R&R curve, recognize that muscle tissue sets the limit for tissue breakdown, and also recognize that any practical real-time system for dealing with pressure ulcer risk will have to rely on measurement of interface pressure at the patient's skin rather than measurement of the pressure experienced by the muscle tissue.

### SUMMARY

The present invention may comprise one or more of the features recited in the appended claims and/or one or more of the following features or combinations thereof.

The subject matter described herein includes a method of accommodating pressure ulcer vulnerability of an occupant of an occupant support. The method comprises the steps of A) establishing a generic relationship between pressure exerted on an individual's skin versus duration, which relationship accounts for an offset between skin pressure tolerance and muscle pressure tolerance, B) adjusting the relationship, or output thereof, based on a risk spectrum which reflects an occupant population and relates the occupant's tolerance to an occupant specific parameter, and C) employing the adjusted relationship to determine the occupant's temporal tolerance of a given skin pressure.

The subject matter described herein also includes a method of managing pressure ulcer risk of an occupant of an occupant support. The method comprises A) determining a tolerable parameter from a relationship relating the tolerable parameter to a monitored parameter and an occupant specific parameter, B) comparing the magnitude of a measured parameter to the magnitude of the tolerable parameter, and C) taking an action if the magnitude of the measured parameter compares unfavorably to the magnitude of the tolerable parameter.

The subject matter described herein also includes an occupant support adapted to manage pressure ulcer risk of an occupant thereof. The occupant support comprises a frame, a mattress supported by the frame, a pressure sensing system for monitoring pressure imposed by the mattress on the occupant's skin, a timer for determining an interval of time during which the occupant is exposed to a range of pressures, and a controller adapted to detect tolerance exceedance as a function of a) an occupant specific parameter and b) the sensed pressure, the time interval or both, the controller also being adapted to respond to an exceedance.

### BRIEF DESCRIPTION OF THE DRAWINGS

The foregoing and other features of the various embodiments of the occupant support, method of managing pressure ulcer risk and method of accommodating pressure ulcer vulnerability described herein will become more apparent from the following detailed description and the accompanying drawings in which:

FIG. 1 is the aforementioned, Reswick and Rogers (R&R) empirical pressure-time curve.

FIG. 2 is a graph of pressure expressed in kilo-Pascals (kPa) versus time expressed in minutes from an empirical study (Linder-Ganz E., Gefen A. Mechanical Compression-Induced Pressure Sores in Rat Hindlimb; Muscle Stiffness, Histology, and Computer Models. J. Appl. Physiol. 2004; 96:2034-2049).

FIG. 3 is a comparison of the R&R curve of FIG. 1 (dashed line), the Linder-Ganz et al. curve of FIG. 2 (solid line), and a generic pressure-time tolerance relationship (dash-dot line).

FIG. 4 is a graph showing the generic pressure-time tolerance relationship curve of FIG. 3 along with two curve fragments reflecting adjustments for a patient specific risk factor.

FIG. 5 is a schematic side elevation view of a hospital bed including a mattress.

FIG. 6 is a plan view of the hospital bed of FIG. 5 with a portion of the mattress removed to expose an array of deflated turn assist bladders.

FIG. 7 is a schematic head end elevation view showing the left turn assist bladders of FIG. 6 having been inflated.

FIG. 8 is a plan view of the mattress of FIGS. 5-6 showing a pressure sensing pad resting on the mattress for monitoring skin or interface pressure of an occupant of the mattress and also including a schematic of a controller.

FIG. 9 is a graphical representation of an example control schedule that may be used by the controller of FIG. 8 to relate an occupant specific parameter to occupant skin pressure, time or both and in which the occupant specific parameter is Braden score.

FIG. 10 is another graphical representation of an example control schedule in which the occupant specific parameter is risk category.

FIG. 11 is another graphical representation of an example control schedule in which the occupant specific parameter is an occupant weight range.

FIG. 12 is a block diagram of a method of managing pressure ulcer risk of an occupant of an occupant support, the method being one that determines if the duration of time that the occupant has been subject to a monitored pressure compares favorably to his or her tolerance to that pressure.

FIG. 12A is a graphical representation related to the method of FIG. 12.

FIG. 13 is a block diagram of a method of managing pressure ulcer risk of an occupant of an occupant support, the method being one that determines if a skin pressure that the occupant has experienced for a monitored interval of time exceeds his tolerance to experience that pressure for that interval of time.

FIG. 13A is a graphical representation related to the method of FIG. 13.

### DETAILED DESCRIPTION

### Method of Accommodating Pressure Ulcer Vulnerability of an Occupant of an Occupant Support and Development of the Method

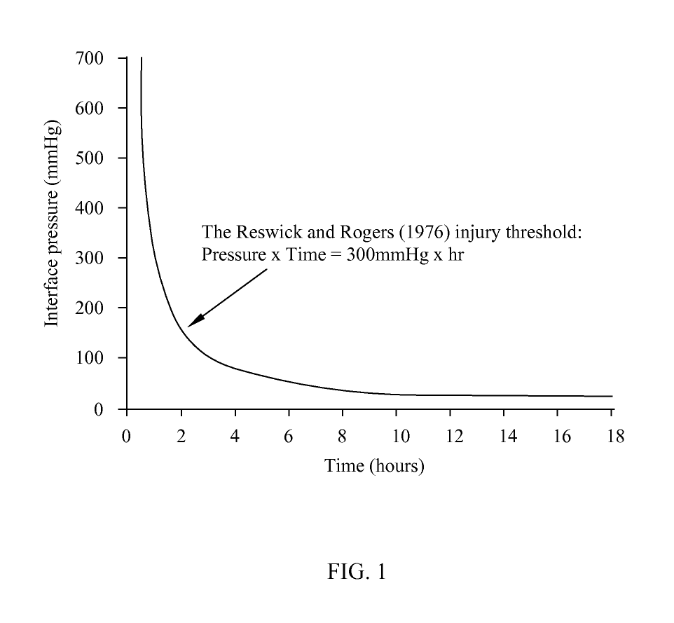

FIG. 1 is the aforementioned, Reswick and Rogers (R&R) empirical pressure-time curve. As already noted the curve defines a “50/50” boundary, but is of questionable validity for very short and very long intervals of time, the curve is not patient specific or patient-class specific, and the curve does not account for the facts that 1) muscle tissue sets the limit for tissue breakdown and 2) the magnitude of the pressure exerted on a patient's skin is not the same as the magnitude of the pressure exerted on the muscle tissue.

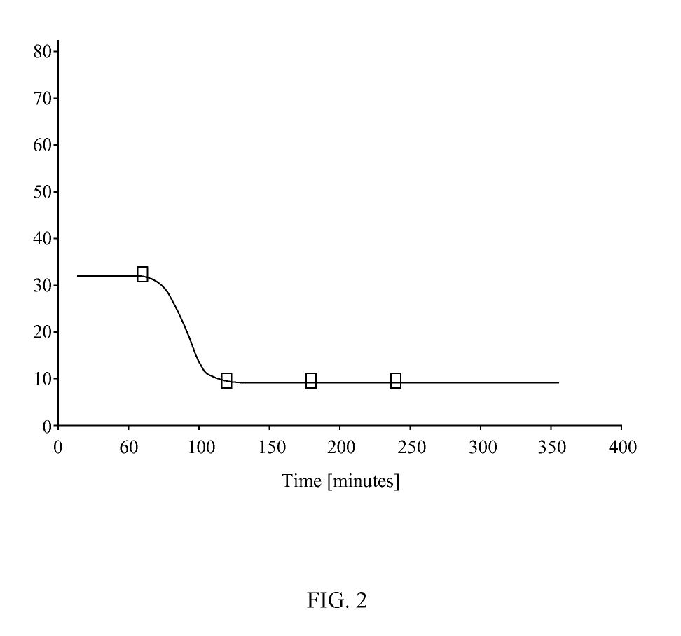

FIG. 2 is a graph of pressure expressed in kilo-Pascals (kPa) versus time expressed in minutes. The curve (hereinafter the L-G curve) is the result of an empirical study (Linder-Ganz E., Gefen A. Mechanical Compression-Induced Pressure Sores in Rat Hindlimb; Muscle Stiffness, Histology, and Computer Models. J. Appl. Physiol. 2004; 96:2034-2049) which evaluated the pressure tolerance of tissue for pressures applied directly to the muscle tissue. Like the R&R curve, the L-G curve represents a 50/50 boundary and is not patient or patient-class specific. Although the L-G curve reflects the tolerance (or vulnerability) of tissue for pressures applied directly to the muscle tissue, it does not correlate skin pressure to pressure applied directly to the muscle tissue (referred to herein as muscle pressure).

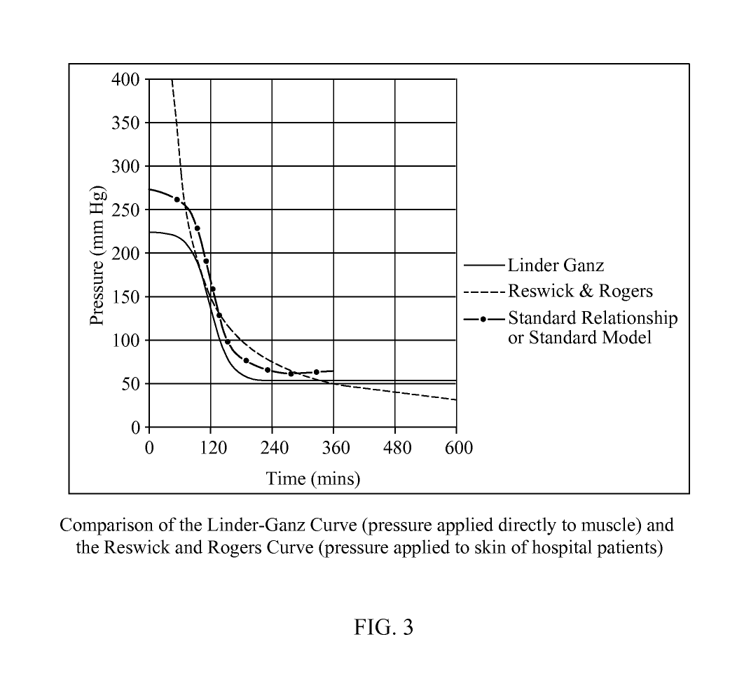

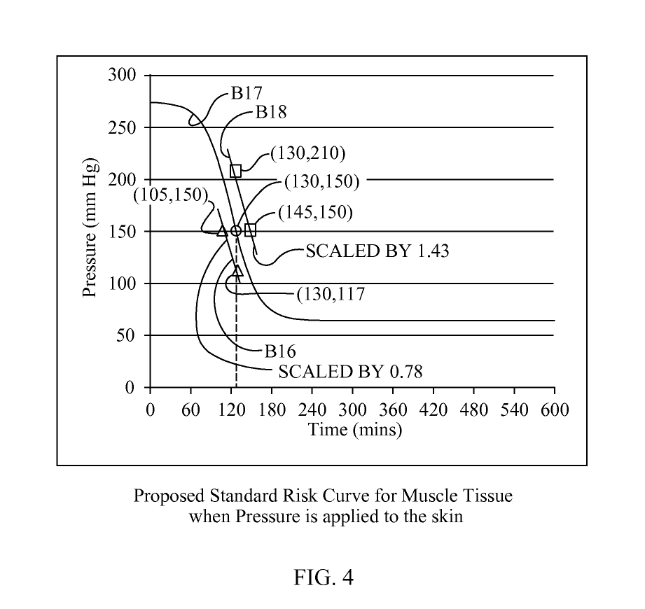

FIG. 3 is a comparison of the R&R curve (dashed line) to the L-G curve (solid line). The graph also includes vertical boundaries at 80 and 360 minutes to delineate the time interval where the R&R curve is believed to be most credible. Given that the L-G curve reflects pressure applied directly to muscle and the R&R curve reflects pressure applied to the skin of hospital patients, it is clear that there is an offset between skin pressure tolerance and muscle pressure tolerance. It is also clear that the offset, whether in the form of a difference or in the form of a multiplicative factor, varies with time. However for the purposes of the occupant support and methods described in this application, a constant multiplicative factor of about 1.22 is satisfactory. That is, multiplying the pressure values of the muscle based L-G curve by 1.22 yields a generic pressure-time tolerance relationship which is grounded in the muscle-based L-G curve but is expressed in terms of skin pressure which, as a practical matter, is more readily available for measurement than is pressure on the muscle. The generic pressure-time tolerance relationship, which is also referred to herein as the “standard relationship” or “standard model” or “standard curve” is shown as a dash-dot line in FIG. 3 and is also shown in FIG. 4 along with two curve fragments resulting from having multiplied the standard curve by factors of 1.43 and 0.78 for reasons explained below. The generic relationship of pressure versus duration has the advantage of being muscle based (by virtue of the L-G study) while being a function of a readily measurable parameter (skin pressure) and is in reasonably close agreement with the skin pressure based R&R curve, at least in the time range where the R&R curve is considered to be most valid. Because the generic relationship is based on the R&R curve and the L-G curve, both of which are empirical, the generic relationship is also empirical. Like the R&R curve and the L-G curve, the generic relationship represents a “50/50” threshold. The generic relationship is not, however, specific to an individual patient or class of patients.

In order to achieve patient specificity or patient class specificity the generic relationship of FIG. 4 (also shown as the dash-dot line of FIG. 3) is adjusted based on a risk spectrum that relates a particular occupant's tolerance to an occupant specific parameter. Table 1 shows an example nonmonotonic risk spectrum where Braden score is the occupant specific parameter. Lower Braden scores correspond to higher risk and vice versa. The column labeled “Relative Risk” shows the ratio R_{B}/R_{MEAN} where R_{B} is likelihood that a patient with a given Braden score of “B” will develop a pressure ulcer and R_{MEAN} is the likelihood that a patient having a mean risk of developing a pressure ulcer will develop a pressure ulcer. For example, a patient with a Braden score of 10 is 3.67 times more likely to develop a pressure ulcer than is a mean (average) patient. The table can also be used to establish the relative risk between any two patients having different Braden scores. For example a patient with a Braden score of 10 is about 1.26 times more likely to develop a pressure ulcer than is a patient whose Braden score is 12 (3.67/2.91=1.26). The column labeled “Relative Risk Normalized to Braden Score=17” shows the relative risk ratios normalized to the relative risk of a patient whose Braden score is 17.

TABLE 1

| | | Relative Risk |
|---|---|---|
| | | Normalized to |
| | Relative Risk | Braden Score = |
| Braden Score | (R_{B}/R_{MEAN}) | 17 |
| 6 | 3.55 | 3.26 |
| 7 | 3.79 | 3.48 |
| 8 | 3.96 | 3.63 |
| 9 | 3.91 | 3.59 |
| 10 | 3.67 | 3.37 |
| 11 | 3.33 | 3.06 |
| 12 | 2.91 | 2.67 |
| 13 | 2.65 | 2.43 |
| 14 | 2.28 | 2.09 |
| 15 | 1.68 | 1.54 |
| 16 | 1.39 | 1.28 |
| 17 | 1.09 | 1.00 |
| 18 | 0.76 | 0.70 |
| 19 | 0.51 | 0.47 |
| 20 | 0.34 | 0.31 |
| 21 | 0.24 | 0.22 |
| 22 | 0.2 | 0.18 |
| 23 | 0.17 | 0.16 |

The relative risks in table 1 are based on empirical data revealing the proportion of a large population of patients (approximately 88,000), each having a particular Braden score, who actually developed a pressure ulcer in a clinical setting. The relative risks of a population of interest could be based on any database of interest and/or could be derived from available literature such as “Factors Associated with Pressure Ulcers in Adults in Acute Care Hospitals”, Andrea R. Fisher et al., Advances in Skin & Wound Care, Vol. 17 No 2 and “Predictors of Pressure Ulcers in Adult Critical Care Patients”, Jill Cox.

In an actual clinical setting a caregiver will adjust the standard relationship of FIG. 4 based on the risk spectrum of table 1 to determine a patient specific tolerance. For example, the protocol followed by a health care facility may specify that a patient whose Braden score is 17 is a “standard” patient. If a caregiver's Braden assessment of a patient results in that patient being assigned a Braden score of 17, the adjustment applied to FIG. 4 would be 1.0, i.e. the pressure values of FIG. 4 would be multiplied by 1.0. The patient's tolerance of a pressure of, say, 150 mm Hg would be about 130 minutes (circular symbol of FIG. 4).

For a second patient whose Braden score is 18 and therefore is at lower risk than the “standard” patient, the adjustment applied to the pressure values of FIG. 4 would be about 1.43 (the relative risk of 1.09 associated with a standard patient (Braden score=17) divided by the relative risk of 0.76 associated with the patient whose Braden score is 18 (1.09/0.76=1.43)—or alternatively the inverse of the normalized risk ratio for a Braden score of 18 (1.0/0.7=1.43)). Accordingly the pressure values of FIG. 4 would be multiplied by 1.43 (curve fragment B18 of FIG. 4). That patient's 130 minute skin pressure tolerance would be about 210 mm Hg (150 mm Hg times 1.43). Alternatively, the second patient would be considered to have a duration tolerance of 145 minutes of exposure to a skin pressure of 150 mm Hg. These pressure-time coordinates are indicated by the square data symbols in FIG. 4.

For a third patient whose Braden score is 16 and who therefore has a higher risk than the standard patient, the adjustment applied to the pressure values of FIG. 4 would be 0.78 (the relative risk of 1.09 associated with a standard patient (Braden score=17) divided by the relative risk of 1.39 associated with the patient whose Braden score is 16 (1.09/1.39=0.78) or alternatively the inverse of the normalized risk ratio for a Braden score of 18 (1.0/1.28=0.78)). Accordingly the pressure values of FIG. 4 would be multiplied by 0.78 (curve fragment of FIG. 4). That patient's 130 minute skin pressure tolerance would be about 117 mm Hg (150 mm Hg times 1.4). Alternatively, the third patient would be considered to have a duration tolerance of only about 105 minutes of exposure to a skin pressure of 150 mm Hg. These pressure-time coordinates are indicated by the triangular data symbols in FIG. 4.

Table 2 shows another example risk spectrum that may be used to adjust the standard or generic relationship of FIG. 4. The spectrum of Table 2 uses “Risk Category” as the occupant specific parameter and is based on the same empirical data set used to define the relative risk values of table 1. Each risk category of table 2 reflects a consolidation of two or more of the Braden scores of Table 1. The particulars of the consolidation are shown in Table 3.

TABLE 2

| | Relative Risk |
|---|---|
| | Normalized |
| | to a Low |
| Risk Category | Risk Patient |
| Very High | 13.1 |
| High | 11.4 |
| Moderate | 8.5 |
| Sub-Moderate | 4.2 |
| Low | 1.0 |

TABLE 3

| Risk Category | Braden Score |
|---|---|
| Very High | 6 to 9 |
| High | 10 to 12 |
| Moderate | 13 to 14 |
| Sub-Moderate | 15 to 18 |
| Low | 19-23 |

Table 4 shows another example nonmonotonic risk spectrum that may be used to adjust the standard or generic relationship of FIG. 4. The spectrum of Table 4 uses occupant weight as the occupant specific parameter and is based on the same empirical data set used to define the relative risk values of tables 1 and 2.

TABLE 4

| | Relative Risk |
|---|---|
| | Normalized |
| Weight Range | Weight Range |
| (pounds) | 350-500 |
| 70-99 | 2.14 |
| 100-139 | 1.43 |
| 140-199 | 1.03 |
| 200-269 | 0.79 |
| 270-349 | 0.90 |
| 350-500 | 1.00 |

From the foregoing examples it can be seen that the adjusted relationships can be used to determine the occupant's temporal tolerance of a given skin pressure or to determine the occupant's skin pressure tolerance for a given duration or interval of time.

As already noted, the generic relationship of FIG. 4 represents a “50/50” threshold. Because the adjusted relationships are the generic relationship adjusted to reflect a patient specific parameter, it too is a 50/50 threshold. The underlying data or similar data can be used to establish thresholds other than 50/50 if desired.

### Occupant Support Adapted to Manage Pressure Ulcer Risk of an Occupant Thereof

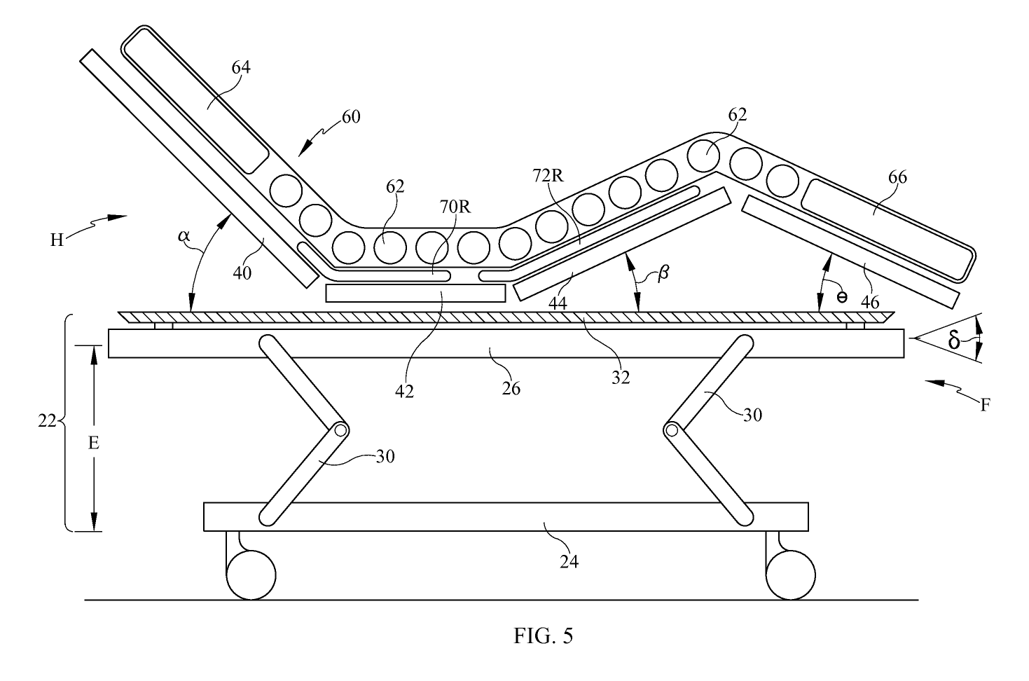

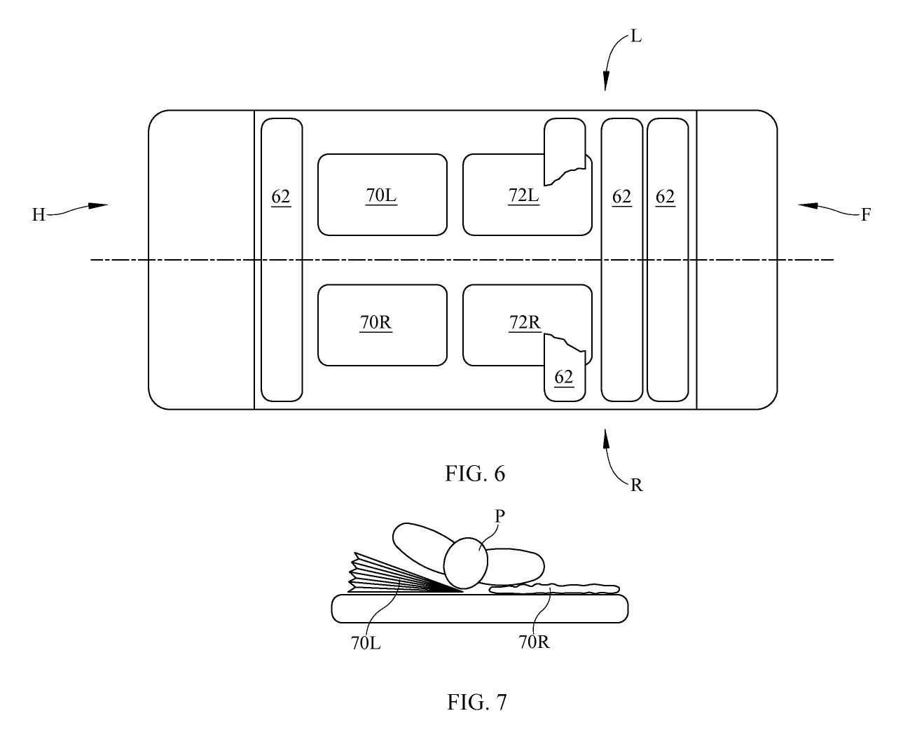

FIGS. 5-6 show an occupant support, such as a hospital bed 20, which extends longitudinally from a head end H to a foot end F and laterally from a left side L to a right side R and which is adapted to manage the risk that an occupant of the bed will develop pressure ulcers. The bed includes a frame 22 comprising a base frame 24 and an elevatable frame 26. The occupant support also includes a lift system represented by links 30 for changing the elevation E of the elevatable frame relative to the base frame. The frame also comprises a weigh frame 32 and a deck supported by the elevatable frame, The illustrated deck comprises a torso or upper body section 40 corresponding approximately to the torso of a bed occupant, a seat section 42 corresponding approximately to the occupant's buttocks, a thigh section 44 corresponding approximately to the occupant's thighs, and a calf section 46 corresponding approximately to the occupant's calves. The upper body, thigh and calf deck sections are orientation adjustable as indicated by angles α, β, θ. The orientation of the elevatable frame is adjustable as indicated by angle δ. The elevation adjustability of the elevatable frame, the orientation adjustability of the deck angles and the orientation adjustability of the elevatable frame are typical of many modern hospital beds, however a hospital bed frame may have other modes of adjustability and/or other adjustable frame components.

The occupant support also includes a mattress 60 supported by the frame. In general a mattress may include pneumatic components, such as inflatable and deflatable primary support bladders 62, and non-pneumatic components such as foam cushions 64, 66. The occupant support may also include turn assist bladders 70R, 70L, 72R, 72L which are normally deflated, (FIG. 5 and FIG. 7 right) but which can be selectively inflated (FIG. 7 left) to rotate the occupant P about a longitudinally extending axis. The mattress and the turn assist bladders, like the frame, may have various adjustable components and modes of adjustability. For example the pressure in bladders 62 may be increased or decreased to achieve greater or lesser firmness, and the turn assist bladders 70, 72 on one lateral side of the bed may be inflated to rotate the patient P to one side or the other as seen in FIG. 7.

Due to the presence of the adjustable frame and mattress components the occupant support can take on a number of states, each corresponding to a particular combination of adjustment settings and/or operational modes.

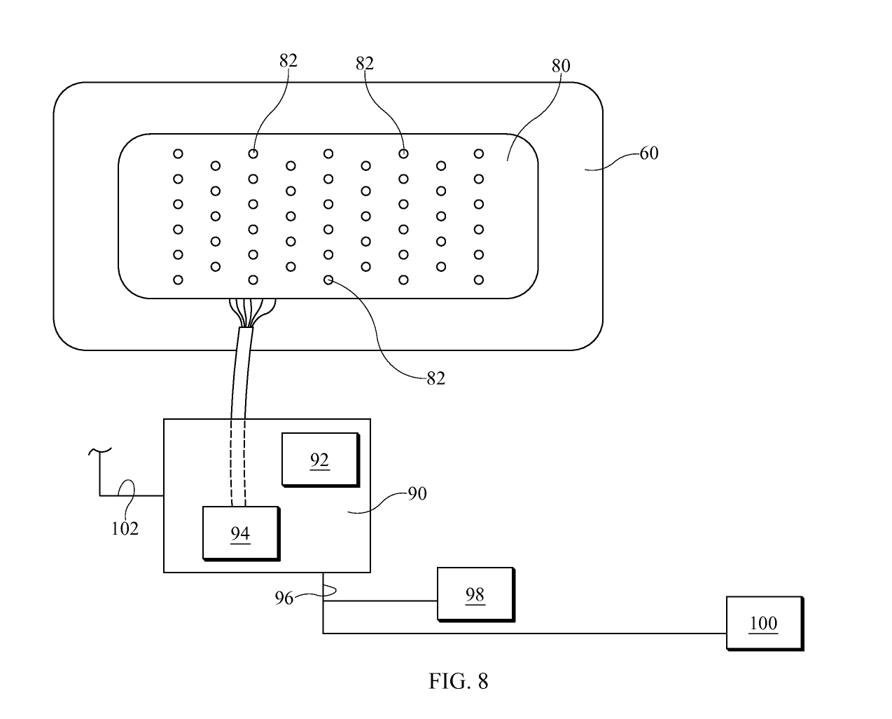

Referring additionally to FIG. 8 the occupant support also includes a pressure sensing or pressure monitoring system. The illustrated pressure sensing system is a sensing mat 80 which includes a multiplicity of pressure sensors 82 and which rests atop the mattress 60. Other pressure monitoring systems may be used instead. The sensors of the sensing mat detect pressure at the patient/mat interface, which is equal to or at least a good approximation of skin pressure. Pressure readings are conveyed to a controller 90.

The occupant support also includes a timer 92, shown as a component of controller 90 for determining an interval of time t during which the occupant is exposed to one or more predefined ranges of pressures or to a pressure that exceeds or is less than a prescribed limit. For example a sensor may detect interface pressure in the range of, say, 130-140 mm Hg. from t0 to t1, then pressure in the range of 150-160 mm Hg from t1 to t2, then pressure in the range of 110-120 mm Hg from t2 to t3 and so forth.

The controller includes a control schedule 94 in the form of a look-up table or one or more equations relating an occupant specific parameter to sensed pressure, time or both. The controller uses the time and pressure information to detect exceedance of an occupant's tolerance for exposure to pressure as a function of 1) an occupant specific parameter and 2) the sensed pressure, the time interval or both. The controller is adapted to respond to the exceedance. One example of a response to exceedance is for the controller to issue a notification 96 of the exceedance, for example by commanding operation of a local aural or visual alarm 98 and/or by sending an alert to a nurse's station 100. A second example of a response is for the controller to issue a command 102 for the frame, the mattress, or both to transition from an existing state to a response state conducive to relieving the exceedance. For example command 102 may be one that commands appropriate actuators to reduce angle α of upper body section 40 from α1 to a shallower angle α2 to relieve pressure on the occupant's buttocks. In another example command 102 may be one that commands a pump to vent air from bladders 62 to decrease interface pressure. In another example the command may be one that commands a blower and/or pump to repeatedly inflate and deflate left turn assist bladders 70L, 72L and right turn assist bladders 70R, 72R out of phase with each other to gently rock the occupant laterally back and forth thereby transferring pressure from one side of the occupant's body to the other for acceptably short duration intervals of time. The response may be a simple response such as any one of the three example actions just described, or may be a composite action, for example all of the three example actions.

One example of the tolerance exceedance detected by the controller is exceedance of a temporal tolerance for a given skin pressure. For example, referring to FIG. 4 and assuming that the occupant is a “standard” occupant, if the controller detects a substantially steady pressure of about 150 mm Hg, it would declare a temporal exceedance after about 130 minutes.

Another example of the tolerance exceedance is exceedance of a skin pressure tolerance for a given duration. For example, referring to FIG. 4 and assuming that the occupant is a “standard” occupant (curve B17), after 60 minutes of monitoring the controller would declare an exceedance if the monitored pressure had been equal to or greater than about 270 mm Hg for substantially all of the 60 elapsed minutes. If no exceedance is declared the controller continues to monitor pressure and time. After 30 more minutes (a total of 90 elapsed minutes) the controller would declare an exceedance if the monitored pressure had been equal to or greater than about 235 mm Hg for substantially all of the 90 elapsed minutes. If no exceedance is declared the controller continues to monitor pressure and time. After 30 more minutes (a total of 120 elapsed minutes) the controller would declare an exceedance if the monitored pressure had been equal to or greater than about 150 mm Hg for substantially all of the 120 elapsed minutes. The time intervals in the foregoing examples are illustrative and are not necessarily representative of those that would be used in practice.

Other evaluation schemes may also be suitable. For example a set of pressure-time conditions that might otherwise cause the controller to declare an exceedance might be disregarded, at least temporarily, if the pressure-time history revealed that the occupant had previously been exposed to particularly low interface pressures.

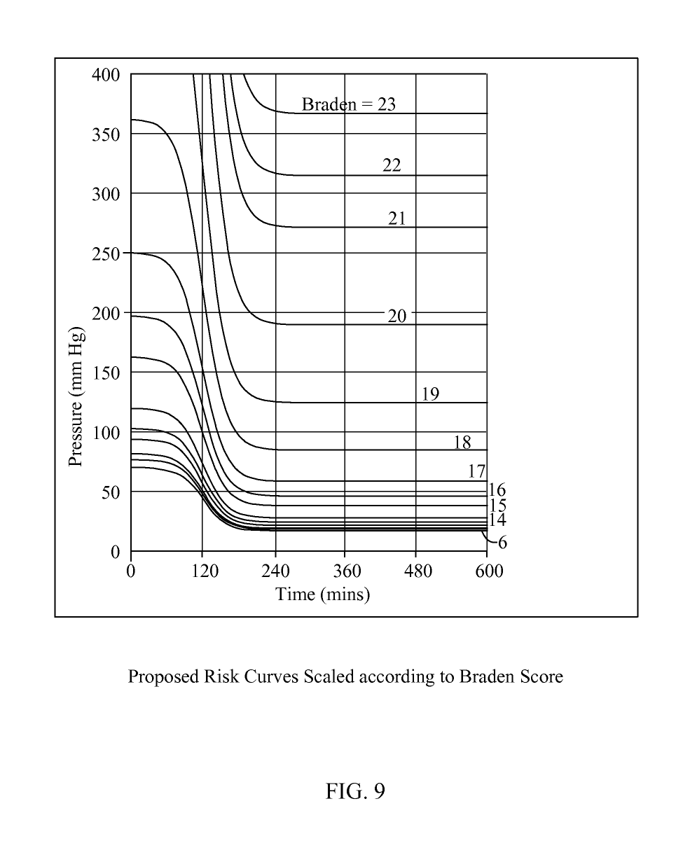

Table 5 shows an example control schedule 94 that controller 90 can use to relate an occupant specific parameter to skin pressure (shown in the table in units of mm Hg), time or both. The control schedule may be in the form of a look-up table as shown below, or one or more equations, or other satisfactory relationship relating the occupant specific parameter to sensed pressure and/or time. For example rather than use a bivariate lookup table the controller may use a univariate lookup table (e.g. representing pressure as a function of time) and simply multiply the output of the table by a factor based on the risk spectrum of table 1. The example control schedule of Table 5 is one of skin pressure as a function of time for a variety of Braden scores B. The controller includes logic to interpolate between table entries. The same control schedule is presented in graphical form in FIG. 9.

TABLE 5

| | Pressure | Pressure | Pressure | Pressure | Pressure | Pressure |
|---|---|---|---|---|---|---|
| Time - | for B = | for B = | for B = | for B = | for B = | for B = |
| Minutes | 6 | 7 | 8 | 9 | 10 | 11 |
| 0 | 81 | 76 | 72 | 73 | 78 | 86 |
| 30 | 80 | 75 | 71 | 72 | 77 | 85 |
| 60 | 75 | 70 | 67 | 68 | 72 | 80 |
| 80 | 71 | 67 | 64 | 65 | 69 | 76 |
| 100 | 63 | 59 | 57 | 57 | 61 | 67 |
| 120 | 48 | 45 | 43 | 44 | 47 | 51 |
| 140 | 33 | 31 | 29 | 30 | 32 | 35 |
| 160 | 27 | 25 | 24 | 24 | 26 | 29 |
| 180 | 21 | 19 | 18 | 19 | 20 | 22 |
| 200 | 19 | 18 | 17 | 17 | 18 | 20 |
| 240 | 18 | 17 | 16 | 16 | 17 | 19 |
| | Pressure | Pressure | Pressure | Pressure | Pressure | Pressure |
| Time - | for B = | for B = | for B = | for B = | for B = | for B = |
| Minutes | 12 | 13 | 14 | 15 | 16 | 17 |
| 0 | 99 | 108 | 126 | 171 | 206 | 263 |
| 30 | 97 | 107 | 124 | 168 | 204 | 260 |
| 60 | 91 | 100 | 117 | 158 | 191 | 244 |
| 80 | 87 | 96 | 111 | 151 | 183 | 233 |
| 100 | 77 | 85 | 98 | 134 | 161 | 206 |
| 120 | 59 | 64 | 75 | 102 | 123 | 157 |
| 140 | 40 | 44 | 51 | 69 | 83 | 106 |
| 160 | 33 | 36 | 42 | 57 | 68 | 87 |
| 180 | 25 | 28 | 32 | 44 | 53 | 67 |
| 200 | 23 | 25 | 29 | 40 | 48 | 62 |
| 240 | 22 | 24 | 28 | 38 | 46 | 58 |
| | Pressure | Pressure | Pressure | Pressure | Pressure | Pressure |
| Time - | for B = | for B = | for B = | for B = | for B = | for B = |
| Minutes | 18 | 19 | 20 | 21 | 22 | 23 |
| 0 | 377 | >400 | >400 | >400 | >400 | >400 |
| 30 | 372 | >400 | >400 | >400 | >400 | >400 |
| 60 | 350 | >400 | >400 | >400 | >400 | >400 |
| 80 | 334 | >400 | >400 | >400 | >400 | >400 |
| 100 | 295 | >400 | >400 | >400 | >400 | >400 |
| 120 | 225 | 335 | >400 | >400 | >400 | >400 |
| 140 | 153 | 227 | 341 | >400 | >400 | >400 |
| 160 | 125 | 187 | 280 | 397 | >400 | >400 |
| 180 | 96 | 144 | 215 | 305 | 366 | >400 |
| 200 | 88 | 132 | 197 | 280 | 336 | 395 |
| 240 | 83 | 124 | 187 | 264 | 317 | 373 |

One example of the tolerance exceedance detected by the controller is exceedance of a temporal tolerance for a given skin pressure. For example, referring to FIG. 9 and assuming that the occupant has a Braden score of 18, if the controller detects a substantially steady pressure of about 220 mm Hg, it would declare a temporal exceedance after about 120 minutes.

Another example of the tolerance exceedance is exceedance of a skin pressure tolerance for a given duration of time. Continuing to refer to FIG. 9 and continuing to assume the occupant has a Braden score of 18, after 60 minutes of monitoring the controller would declare an exceedance if the monitored pressure had been equal to or greater than about 350 mm Hg for substantially all of the 60 elapsed minutes. If no exceedance is declared the controller continues to monitor pressure and time. After 30 more minutes (a total of 90 elapsed minutes) the controller would declare an exceedance if the monitored pressure had been equal to or greater than about 320 mm Hg for substantially all of the 90 elapsed minutes. If no exceedance is declared the controller continues to monitor pressure and time. After 30 more minutes (a total of 120 elapsed minutes) the controller would declare an exceedance if the monitored pressure had been equal to or greater than about 220 mm Hg for substantially all of the 120 elapsed minutes. The time intervals in the foregoing examples are illustrative and are not necessarily representative of those that would be used in practice.

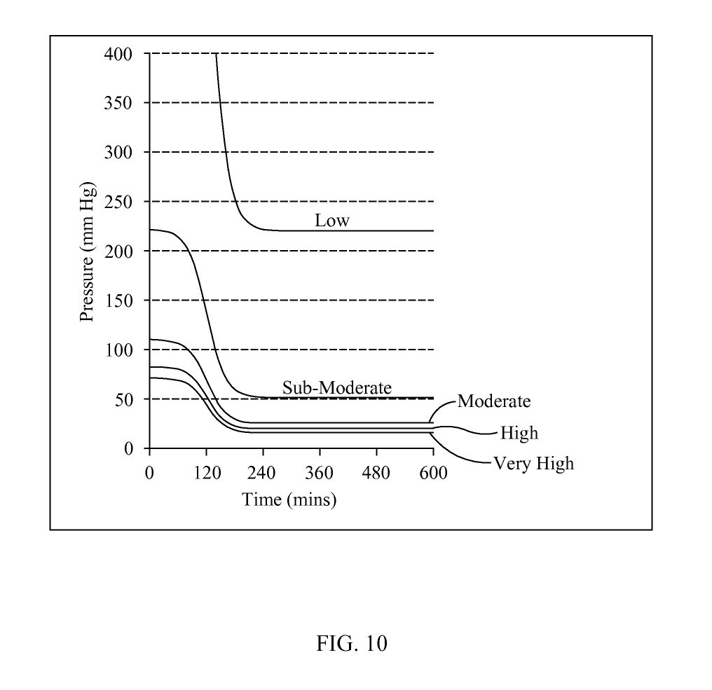

Table 6 and FIG. 10 show another example control schedule 94 that controller 90 can use to relate an occupant specific parameter to skin pressure, time or both. The control schedule may be in the form of a look-up table, as shown below, or one or more equations, or other satisfactory relationship relating the occupant specific parameter to sensed pressure and/or time. For example rather than use a bivariate lookup table the controller may use a univariate lookup table (e.g. representing pressure as a function of time) and simply multiply the output of the table by a factor based on the risk spectrum of table 2. The example control schedule of Table 6 is one of skin pressure as a function of time for a variety of risk categories.

TABLE 6

| | Pressure - mm Hg | | | | |
|---|---|---|---|---|---|
| | Very | | | Sub- | |
| Time - | High | High | Moderate | Moderate | Low |
| Minutes | Risk | Risk | Risk | Risk | Risk |
| 0 | 75 | 87 | 116 | 233 | >400 |
| 30 | 74 | 86 | 115 | 230 | >400 |
| 60 | 70 | 81 | 108 | 216 | >400 |
| 80 | 67 | 77 | 103 | 206 | >400 |
| 100 | 59 | 68 | 91 | 183 | >400 |
| 120 | 45 | 52 | 69 | 139 | >400 |
| 140 | 31 | 35 | 47 | 94 | 400 |
| 160 | 25 | 29 | 39 | 77 | 328 |
| 180 | 19 | 22 | 30 | 60 | 252 |
| 200 | 18 | 20 | 27 | 55 | 231 |
| 240 | 17 | 19 | 26 | 52 | 219 |

Each category of Table 6 and FIG. 10 is a consolidation of two or more Braden scores of Table 5 and FIG. 9 as seen in Table 7:

TABLE 7

| Risk Category | Braden Score |
|---|---|
| Very High | 6 to 9 |
| High | 10 to 12 |
| Moderate | 13 to 14 |
| Sub-Moderate | 15 to 18 |
| Low | 19-23 |

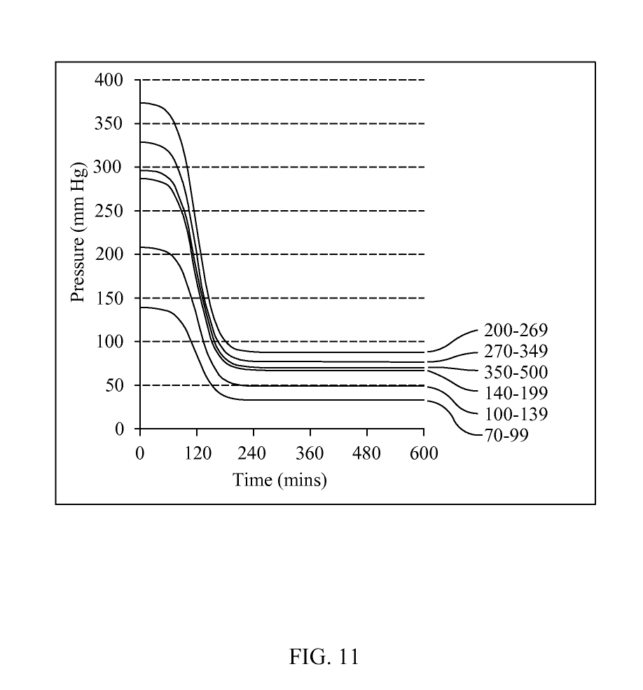

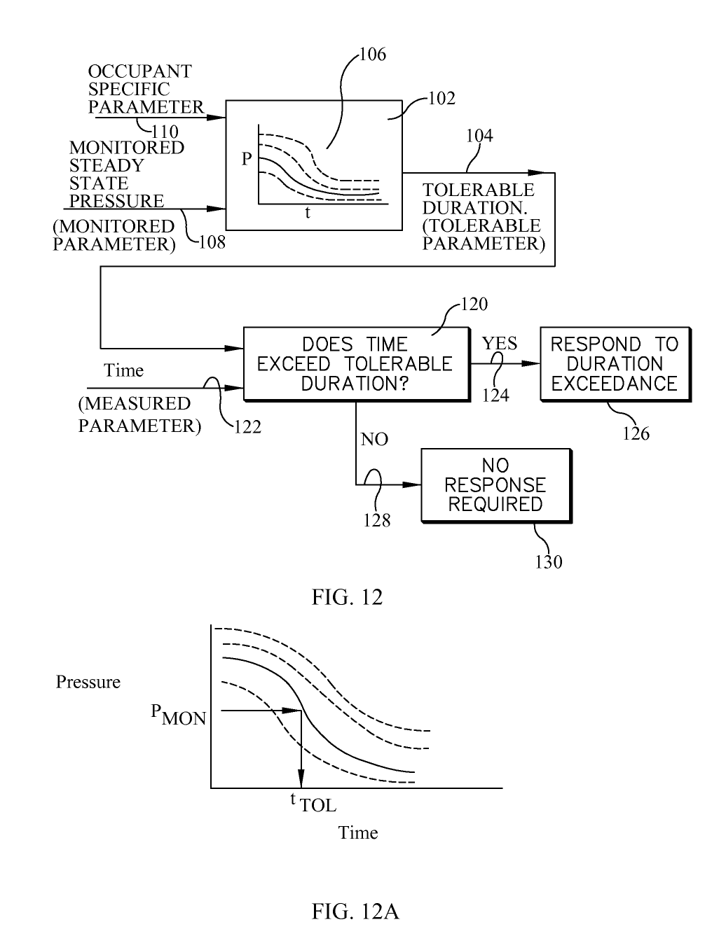

Table 8 and FIG. 11 show another example control schedule 94 that controller 90 could use to relate an occupant specific parameter to skin pressure, time or both. The control schedule may be in the form of a look-up table, as shown below, or one or more equations, or other satisfactory relationship relating the occupant specific parameter to sensed pressure and/or time. For example rather than use a bivariate lookup table the controller may use a univariate lookup table (e.g. representing pressure as a function of time) and simply multiply the output of the table by a factor based on the risk spectrum of table 4. The example control schedule of Table 8 is one of skin pressure as a function of time for a variety of ranges of occupant weights.

TABLE 8

| | Pressure - mm Hg | | | | | |
|---|---|---|---|---|---|---|
| | Weight Range (pounds) | | | | | |
| | 70-99 | 100-139 | 140-199 | 200-269 | 270-349 | 350-500 |
| Time | Weight Class | | | | | |
| (minutes) | A | B | C | D | E | F |
| 0 | 139 | 208 | 289 | 376 | 331 | 298 |
| 30 | 137 | 205 | 285 | 371 | 326 | 294 |
| 60 | 129 | 193 | 268 | 349 | 307 | 277 |
| 80 | 123 | 184 | 256 | 333 | 293 | 264 |
| 100 | 109 | 163 | 226 | 294 | 259 | 233 |
| 120 | 83 | 124 | 172 | 224 | 197 | 178 |
| 140 | 56 | 84 | 117 | 152 | 134 | 121 |
| 160 | 46 | 69 | 96 | 125 | 110 | 99 |
| 180 | 36 | 53 | 74 | 96 | 84 | 76 |
| 200 | 33 | 49 | 68 | 88 | 77 | 70 |
| ≧240 | 31 | 46 | 64 | 83 | 73 | 66 |

### Method of Managing Pressure Ulcer Risk of an Occupant of an Occupant Support

FIGS. 12A, 12B 13A and 13B are block diagrams and a depiction of a pressure-time graph showing a method of managing the risk that an occupant of an occupant support will develop pressure ulcers.

Referring first to FIGS. 12 and 12A the method begins at block 102 where the method determines the magnitude of a tolerable parameter 104 from a bivariate relationship 106 relating the tolerable parameter to the magnitude of a monitored parameter 108 and an occupant specific parameter 110 (the solid line in relationship 106 is the line specific to the occupant of interest). Alternatively, the relationship may be a univariate relationship the output of which is multiplied by an appropriate factor based on a risk spectrum, such as the spectra of table 1, 2 or 4. In the specific method of FIGS. 12 and 12A the monitored parameter is skin pressure and the tolerable parameter is a tolerable duration or interval of time. According to the method, relationship 106 reveals the interval of time t_{TOL} that an occupant characterizable by the occupant specific parameter can tolerate the monitored skin pressure P_{MON}. Skin pressure 106 is a steady state pressure or a quasi-steady state pressure because the method may not be reliable when the monitored pressure undergoes significant transients.

At block 120 the method compares the magnitude of the tolerable parameter 104 to the magnitude of a measured parameter 122. Because input 104 to block 120 is a tolerable time interval, the measured parameter is time, i.e. the period of time that the occupant has been subjected to the monitored pressure. If the duration of time that the occupant has been subjected to the monitored pressure compares unfavorably to his or her temporal tolerance (104 or t_{TOL}) for that pressure, for example if the measured time exceeds his or her temporal tolerance to the monitored pressure, the method follows branch 124 and responds (block 126). Otherwise, if the duration of time that the occupant has been subjected to the monitored pressure compares favorably to his or her tolerance, for example if the measured time does not exceed his or her tolerance to the monitored pressure, the method follows branch 128 and takes no action (block 130) other than to continue carrying out the determining and comparing steps of blocks 106 and 120.

In the context of a hospital bed, one example response at block 126 is to issue a notification such as notification 96 of FIG. 8 to a local aural or visual alarm 98 and/or to a nurse's station 100. A second example response is to modify the state of the bed, for example placing the bed in a state conducive to relieving the exceedance of the occupant's tolerance.

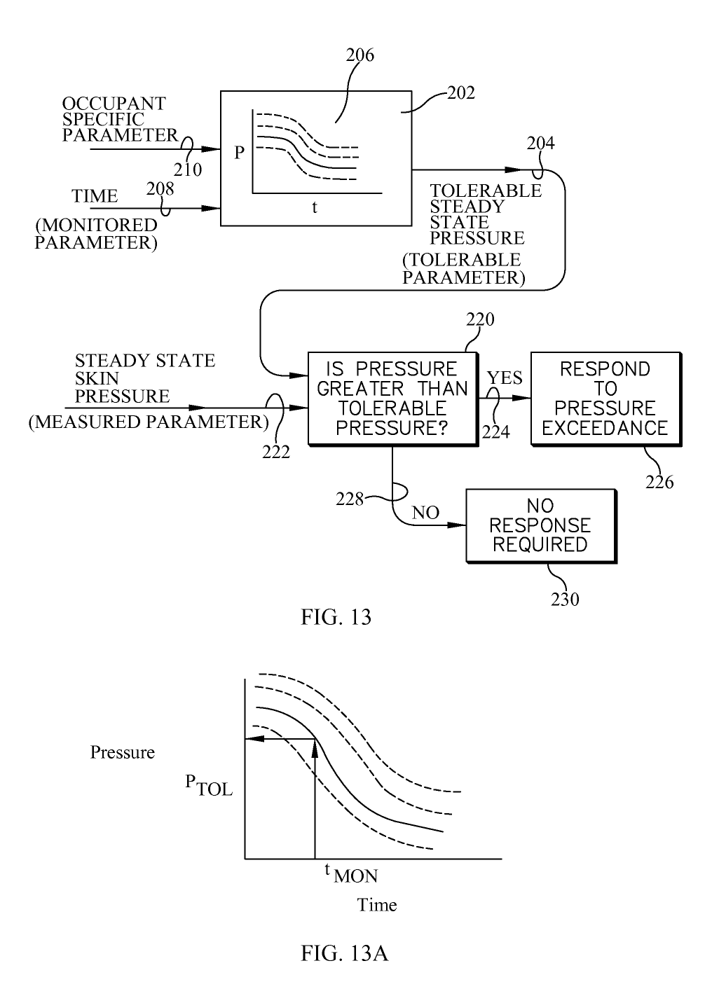

Referring now to FIGS. 13 and 13A, an alternate method begins at block 202 where the method determines the magnitude of a tolerable parameter 204 from a relationship 206 relating the tolerable parameter to the magnitude of a monitored parameter 208 and an occupant specific parameter 210 (the solid line in relationship 206 is the line specific to the occupant of interest). In the specific method of FIGS. 13 and 13A the monitored parameter is time and the tolerable parameter is a tolerable steady state or quasi-steady state skin pressure. According to the method, relationship 206 reveals the skin pressure P_{TOL} that an occupant characterizable by the occupant specific parameter can tolerate provided that the occupant has not been exposed to that pressure for more than the monitored interval of time t_{MON}.

At block 220 the method compares the magnitude of the tolerable parameter 204 to the magnitude of a measured parameter 222. Because input 204 to block 220 is a tolerable skin pressure, the measured parameter is measured steady time or quasi-steady state skin pressure. If it is determined at block 220 that the pressure the occupant has been subjected to for the monitored interval of time t_{MON} exceeds his or her pressure tolerance P_{TOL} for that interval of time, the comparison is unfavorable and the method follows branch 224 and responds (block 226). Otherwise, if it is determined at block 220 the pressure the occupant has been subjected to for the monitored interval of time does not exceed his or her pressure tolerance for that interval of time, the method follows branch 228 and takes no action (block 230) other than to continue the determining and comparing steps of blocks 206 and 220.

In the context of a hospital bed, one example response at block 226 is to issue a notification such as notification 96 of FIG. 8 to a local aural or visual alarm 98 and/or to a nurse's station 100. A second example response is to modify the state of the bed, for example placing the bed in a state conducive to relieving the exceedance of the occupant's tolerance.

Examples of relationships 106, 206 include the relationship of table 5 and FIG. 9 where the occupant specific parameter is Braden score, the relationship of table 6 and FIG. 10 where the occupant specific parameter is risk category, and the relationship of table 8 and FIG. 11 where the occupant specific parameter is occupant weight class. All three relationships introduce some degree of occupant specificity into the method. As already noted each of those relationships is based on the standard relationship of FIG. 4 and an empirical database of the experience of approximately 88,000 patents. However other databases may be used instead to derive occupant specific adjustments to FIG. 4. Moreover, relationships other than that of FIG. 4 can be used as future research reveals new information about pressure ulcer tolerance of the more general population or of specific target populations. In addition, analysis of the underlying data can be used to develop relationships similar to that of FIG. 4 but which represent a threshold other than a 50/50 threshold.

Although this disclosure refers to specific embodiments, it will be understood by those skilled in the art that various changes in form and detail may be made without departing from the subject matter set forth in the accompanying claims.

I claim:

1. A method of accommodating pressure ulcer vulnerability of an occupant of an occupant support comprising:
A) establishing a generic relationship between pressure exerted on an individual's skin versus duration, the relationship accounting for an offset between skin pressure tolerance and muscle pressure tolerance;
B) adjusting the relationship or an output thereof based on a risk spectrum that relates the occupant's tolerance to an occupant specific parameter, the risk spectrum reflecting an occupant population; and
C) employing the adjusted relationship to determine the occupant's temporal tolerance of a given skin pressure.

2. The method of claim 1 wherein the employing step is replaced by the step of:
C) employing the adjusted relationship to determine the occupant's skin pressure tolerance for a given duration.

3. The method of claim 1 wherein the established generic relationship represents an approximately 50% risk of pressure ulcer development.

4. The method of claim 1 wherein the adjusted relationship represents an approximately 50% risk of pressure ulcer development.

5. The method of claim 1 wherein the established generic relationship is an empirically based relationship.

6. The method of claim 1 wherein the risk spectrum is empirically based.

7. The method of claim 1 wherein the occupant specific parameter is a Braden score.

8. The method of claim 7 wherein the risk spectrum is a relationship of relative risk as a function of Braden score as set forth below:

| | Relative |
|---|---|
| Braden Score | Risk |
| 6 | 3.55 |
| 7 | 3.79 |
| 8 | 3.96 |
| 9 | 3.91 |
| 10 | 3.67 |
| 11 | 3.33 |
| 12 | 2.91 |
| 13 | 2.65 |
| 14 | 2.28 |
| 15 | 1.68 |
| 16 | 1.39 |
| 17 | 1.09 |
| 18 | 0.76 |
| 19 | 0.51 |
| 20 | 0.34 |
| 21 | 0.24 |
| 22 | 0.2 |
| 23 | 0.17 |

9. The method of claim 1 wherein the occupant specific parameter is a risk category.

10. The method of claim 8 wherein the risk spectrum is a relationship of relative risk as a function of risk category as set forth below:

| | Relative |
|---|---|
| Risk Category | Risk |
| Very High | 13.1 |
| High | 11.4 |
| Moderate | 8.5 |
| Sub-Moderate | 4.2 |
| Low | 1.0 |

11. The method of claim 9 wherein the risk categories are related to Braden score as set forth below:

| Risk Category | Braden Score |
|---|---|
| Very High | 6 to 9 |
| High | 10 to 12 |
| Moderate | 13 to 14 |
| Sub-Moderate | 15 to 18 |
| Low | 19-23 |

12. The method of claim 1 wherein the occupant specific parameter is occupant weight.

13. The method of claim 12 wherein the risk spectrum is a relationship of relative risk as a function of occupant weight as set forth below:

| Weight Range | Relative |
|---|---|
| (pounds) | Risk |
| 70-99 | 2.14 |
| 100-139 | 1.43 |
| 140-199 | 1.03 |
| 200-269 | 0.79 |
| 270-349 | 0.90 |
| 350-500 | 1.00 |

14. The method of claim 1 wherein the relationship between skin pressure tolerance and muscle pressure tolerance is a constant factor such that the ratio of skin pressure tolerance to muscle pressure tolerance is approximately 1.22.

15. A method of managing pressure ulcer risk of an occupant of an occupant support comprising:
A) determining a tolerable parameter from a relationship relating the tolerable parameter to a monitored parameter and an occupant specific parameter;
B) comparing the magnitude of a measured parameter to the magnitude of the tolerable parameter; and
C) if the magnitude of the measured parameter compares unfavorably to the magnitude of the tolerable parameter, taking an action.

16. The method of claim 15 wherein the action comprises issuing a notification.

17. The method of claim 15 wherein the action comprises modifying the state of the occupant support.

18. The method of claim 15 wherein the monitored parameter is skin pressure, the tolerable parameter is time, and the measured parameter is time.

19. The method of claim 15 wherein the monitored parameter is time, the tolerable parameter is skin pressure, and the measured parameter is skin pressure.

20. The method of claim 18 wherein the occupant specific parameter is Braden score and the relationship between the tolerable parameter and the monitored parameter is a relationship between pressure, time and Braden score as set forth below:

| | Pressure | Pressure | Pressure | Pressure | Pressure | Pressure |
|---|---|---|---|---|---|---|
| Time - | for B = | for B = | for B = | for B = | for B = | for B = |
| Minutes | 6 | 7 | 8 | 9 | 10 | 11 |
| 0 | 81 | 76 | 72 | 73 | 78 | 86 |
| 30 | 80 | 75 | 71 | 72 | 77 | 85 |
| 60 | 75 | 70 | 67 | 68 | 72 | 80 |
| 80 | 71 | 67 | 64 | 65 | 69 | 76 |
| 100 | 63 | 59 | 57 | 57 | 61 | 67 |
| 120 | 48 | 45 | 43 | 44 | 47 | 51 |
| 140 | 33 | 31 | 29 | 30 | 32 | 35 |
| 160 | 27 | 25 | 24 | 24 | 26 | 29 |
| 180 | 21 | 19 | 18 | 19 | 20 | 22 |
| 200 | 19 | 18 | 17 | 17 | 18 | 20 |
| 240 | 18 | 17 | 16 | 16 | 17 | 19 |
| | Pressure | Pressure | Pressure | Pressure | Pressure | Pressure |
| Time - | for B = | for B = | for B = | for B = | for B = | for B = |
| Minutes | 12 | 13 | 14 | 15 | 16 | 17 |
| 0 | 99 | 108 | 126 | 171 | 206 | 263 |
| 30 | 97 | 107 | 124 | 168 | 204 | 260 |
| 60 | 91 | 100 | 117 | 158 | 191 | 244 |
| 80 | 87 | 96 | 111 | 151 | 183 | 233 |
| 100 | 77 | 85 | 98 | 134 | 161 | 206 |
| 120 | 59 | 64 | 75 | 102 | 123 | 157 |
| 140 | 40 | 44 | 51 | 69 | 83 | 106 |
| 160 | 33 | 36 | 42 | 57 | 68 | 87 |
| 180 | 25 | 28 | 32 | 44 | 53 | 67 |
| 200 | 23 | 25 | 29 | 40 | 48 | 62 |
| 240 | 22 | 24 | 28 | 38 | 46 | 58 |
| | Pressure | Pressure | Pressure | Pressure | Pressure | Pressure |
| Time - | for B = | for B = | for B = | for B = | for B = | for B = |
| Minutes | 18 | 19 | 20 | 21 | 22 | 23 |
| 0 | 377 | >400 | >400 | >400 | >400 | >400 |
| 30 | 372 | >400 | >400 | >400 | >400 | >400 |
| 60 | 350 | >400 | >400 | >400 | >400 | >400 |
| 80 | 334 | >400 | >400 | >400 | >400 | >400 |
| 100 | 295 | >400 | >400 | >400 | >400 | >400 |
| 120 | 225 | 335 | >400 | >400 | >400 | >400 |
| 140 | 153 | 227 | 341 | >400 | >400 | >400 |
| 160 | 125 | 187 | 280 | 397 | >400 | >400 |
| 180 | 96 | 144 | 215 | 305 | 366 | >400 |
| 200 | 88 | 132 | 197 | 280 | 336 | 395 |
| 240 | 83 | 124 | 187 | 264 | 317 | 373 |

21. The method of claim 18 wherein the occupant specific parameter is risk category and the relationship between the tolerable parameter and the monitored parameter is a relationship between pressure, time and risk category as set forth below:

| | Pressure - mm Hg | | | | |
|---|---|---|---|---|---|
| | Very | | | Sub- | |
| Time - | High | High | Moderate | Moderate | Low |
| Minutes | Risk | Risk | Risk | Risk | Risk |
| 0 | 75 | 87 | 116 | 233 | >400 |
| 30 | 74 | 86 | 115 | 230 | >400 |
| 60 | 70 | 81 | 108 | 216 | >400 |
| 80 | 67 | 77 | 103 | 206 | >400 |
| 100 | 59 | 68 | 91 | 183 | >400 |
| 120 | 45 | 52 | 69 | 139 | >400 |
| 140 | 31 | 35 | 47 | 94 | 400 |
| 160 | 25 | 29 | 39 | 77 | 328 |
| 180 | 19 | 22 | 30 | 60 | 252 |
| 200 | 18 | 20 | 27 | 55 | 231 |
| 240 | 17 | 19 | 26 | 52 | 219 |

22. The method of claim 18 wherein the occupant specific parameter is weight and the relationship between the tolerable parameter and the monitored parameter is a relationship between pressure, time and occupant weight as set forth below:

| | Pressure - mm Hg | | | | | |
|---|---|---|---|---|---|---|
| | Weight Range (pounds) | | | | | |
| | 70-99 | 100-139 | 140-199 | 200-269 | 270-349 | 350-500 |
| Time | Weight Class | | | | | |
| (minutes) | A | B | C | D | E | F |
| 0 | 139 | 208 | 289 | 376 | 331 | 298 |
| 30 | 137 | 205 | 285 | 371 | 326 | 294 |
| 60 | 129 | 193 | 268 | 349 | 307 | 277 |
| 80 | 123 | 184 | 256 | 333 | 293 | 264 |
| 100 | 109 | 163 | 226 | 294 | 259 | 233 |
| 120 | 83 | 124 | 172 | 224 | 197 | 178 |
| 140 | 56 | 84 | 117 | 152 | 134 | 121 |
| 160 | 46 | 69 | 96 | 125 | 110 | 99 |
| 180 | 36 | 53 | 74 | 96 | 84 | 76 |
| 200 | 33 | 49 | 68 | 88 | 77 | 70 |
| ≧240 | 31 | 46 | 64 | 83 | 73 | 66 |

23. The method of claim 19 wherein the occupant specific parameter is Braden score and the relationship between the tolerable parameter and the monitored parameter is a relationship between pressure, time and Braden score as set forth below:

| | Pressure | Pressure | Pressure | Pressure | Pressure | Pressure |
|---|---|---|---|---|---|---|
| Time - | for B = | for B = | for B = | for B = | for B = | for B = |
| Minutes | 6 | 7 | 8 | 9 | 10 | 11 |
| 0 | 81 | 76 | 72 | 73 | 78 | 86 |
| 30 | 80 | 75 | 71 | 72 | 77 | 85 |
| 60 | 75 | 70 | 67 | 68 | 72 | 80 |
| 80 | 71 | 67 | 64 | 65 | 69 | 76 |
| 100 | 63 | 59 | 57 | 57 | 61 | 67 |
| 120 | 48 | 45 | 43 | 44 | 47 | 51 |
| 140 | 33 | 31 | 29 | 30 | 32 | 35 |
| 160 | 27 | 25 | 24 | 24 | 26 | 29 |
| 180 | 21 | 19 | 18 | 19 | 20 | 22 |
| 200 | 19 | 18 | 17 | 17 | 18 | 20 |
| 240 | 18 | 17 | 16 | 16 | 17 | 19 |
| | Pressure | Pressure | Pressure | Pressure | Pressure | Pressure |
| Time - | for B = | for B = | for B = | for B = | for B = | for B = |
| Minutes | 12 | 13 | 14 | 15 | 16 | 17 |
| 0 | 99 | 108 | 126 | 171 | 206 | 263 |
| 30 | 97 | 107 | 124 | 168 | 204 | 260 |
| 60 | 91 | 100 | 117 | 158 | 191 | 244 |
| 80 | 87 | 96 | 111 | 151 | 183 | 233 |
| 100 | 77 | 85 | 98 | 134 | 161 | 206 |
| 120 | 59 | 64 | 75 | 102 | 123 | 157 |
| 140 | 40 | 44 | 51 | 69 | 83 | 106 |
| 160 | 33 | 36 | 42 | 57 | 68 | 87 |
| 180 | 25 | 28 | 32 | 44 | 53 | 67 |
| 200 | 23 | 25 | 29 | 40 | 48 | 62 |
| 240 | 22 | 24 | 28 | 38 | 46 | 58 |
| | Pressure | Pressure | Pressure | Pressure | Pressure | Pressure |
| Time - | for B = | for B = | for B = | for B = | for B = | for B = |
| Minutes | 18 | 19 | 20 | 21 | 22 | 23 |
| 0 | 377 | >400 | >400 | >400 | >400 | >400 |
| 30 | 372 | >400 | >400 | >400 | >400 | >400 |
| 60 | 350 | >400 | >400 | >400 | >400 | >400 |
| 80 | 334 | >400 | >400 | >400 | >400 | >400 |
| 100 | 295 | >400 | >400 | >400 | >400 | >400 |
| 120 | 225 | 335 | >400 | >400 | >400 | >400 |
| 140 | 153 | 227 | 341 | >400 | >400 | >400 |
| 160 | 125 | 187 | 280 | 397 | >400 | >400 |
| 180 | 96 | 144 | 215 | 305 | 366 | >400 |
| 200 | 88 | 132 | 197 | 280 | 336 | 395 |
| 240 | 83 | 124 | 187 | 264 | 317 | 373 |

24. The method of claim 19 wherein the occupant specific parameter is risk category and the relationship between the tolerable parameter and the monitored parameter is a relationship between pressure, time and risk category as set forth below:

| | Pressure - mm Hg | | | | |
|---|---|---|---|---|---|
| | Very | | | Sub- | |
| Time - | High | High | Moderate | Moderate | Low |
| Minutes | Risk | Risk | Risk | Risk | Risk |
| 0 | 75 | 87 | 116 | 233 | >400 |
| 30 | 74 | 86 | 115 | 230 | >400 |
| 60 | 70 | 81 | 108 | 216 | >400 |
| 80 | 67 | 77 | 103 | 206 | >400 |
| 100 | 59 | 68 | 91 | 183 | >400 |
| 120 | 45 | 52 | 69 | 139 | >400 |
| 140 | 31 | 35 | 47 | 94 | 400 |
| 160 | 25 | 29 | 39 | 77 | 328 |
| 180 | 19 | 22 | 30 | 60 | 252 |
| 200 | 18 | 20 | 27 | 55 | 231 |
| 240 | 17 | 19 | 26 | 52 | 219 |

25. The method of claim 19 wherein the occupant specific parameter is weight and the relationship between the tolerable parameter and the monitored parameter is a relationship between pressure, time and occupant weight as set forth below:

| | Pressure - mm Hg | | | | | |
|---|---|---|---|---|---|---|
| | Weight Range (pounds) | | | | | |
| | 70-99 | 100-139 | 140-199 | 200-269 | 270-349 | 350-500 |
| Time | Weight Class | | | | | |
| (minutes) | A | B | C | D | E | F |
| 0 | 139 | 208 | 289 | 376 | 331 | 298 |
| 30 | 137 | 205 | 285 | 371 | 326 | 294 |
| 60 | 129 | 193 | 268 | 349 | 307 | 277 |
| 80 | 123 | 184 | 256 | 333 | 293 | 264 |
| 100 | 109 | 163 | 226 | 294 | 259 | 233 |
| 120 | 83 | 124 | 172 | 224 | 197 | 178 |
| 140 | 56 | 84 | 117 | 152 | 134 | 121 |
| 160 | 46 | 69 | 96 | 125 | 110 | 99 |
| 180 | 36 | 53 | 74 | 96 | 84 | 76 |
| 200 | 33 | 49 | 68 | 88 | 77 | 70 |
| ≧240 | 31 | 46 | 64 | 83 | 73 | 66 |

26. An occupant support adapted to manage pressure ulcer risk of an occupant thereof comprising:
a frame;
a mattress supported by the frame;
a pressure sensing system for monitoring pressure imposed by the mattress on the occupant's skin;
a timer for determining an interval of time during which the occupant is exposed to a range of pressures
a controller adapted to detect tolerance exceedance as a function of:
a) an occupant specific parameter and
b) the sensed pressure, the time interval or both and also adapted to respond to the exceedance.

27. The occupant support of claim 26 wherein the response comprises issuance of a notification.

28. The occupant support of claim 26 wherein the mattress is an adjustable mattress and the response comprises issuance of a command for the mattress to transition from an existing state to a response state.

29. The occupant support of claim 26 wherein the frame is an adjustable frame and the response comprises issuance of a command for the frame to transition from an existing state to a response state.

30. The occupant support of claim 26 wherein the tolerance exceedance is exceedance of a temporal tolerance for a given skin pressure.

31. The occupant support of claim 26 wherein the tolerance exceedance is exceedance of a skin pressure tolerance for a given duration.

32. The occupant support of claim 26 including a control schedule as set forth below and wherein the occupant specific parameter is Braden score:

| | Pressure | Pressure | Pressure | Pressure | Pressure | Pressure |
|---|---|---|---|---|---|---|
| Time - | for B = | for B = | for B = | for B = | for B = | for B = |
| Minutes | 6 | 7 | 8 | 9 | 10 | 11 |
| 0 | 81 | 76 | 72 | 73 | 78 | 86 |
| 30 | 80 | 75 | 71 | 72 | 77 | 85 |
| 60 | 75 | 70 | 67 | 68 | 72 | 80 |
| 80 | 71 | 67 | 64 | 65 | 69 | 76 |
| 100 | 63 | 59 | 57 | 57 | 61 | 67 |
| 120 | 48 | 45 | 43 | 44 | 47 | 51 |
| 140 | 33 | 31 | 29 | 30 | 32 | 35 |
| 160 | 27 | 25 | 24 | 24 | 26 | 29 |
| 180 | 21 | 19 | 18 | 19 | 20 | 22 |
| 200 | 19 | 18 | 17 | 17 | 18 | 20 |
| 240 | 18 | 17 | 16 | 16 | 17 | 19 |
| | Pressure | Pressure | Pressure | Pressure | Pressure | Pressure |
| Time - | for B = | for B = | for B = | for B = | for B = | for B = |
| Minutes | 12 | 13 | 14 | 15 | 16 | 17 |
| 0 | 99 | 108 | 126 | 171 | 206 | 263 |
| 30 | 97 | 107 | 124 | 168 | 204 | 260 |
| 60 | 91 | 100 | 117 | 158 | 191 | 244 |
| 80 | 87 | 96 | 111 | 151 | 183 | 233 |
| 100 | 77 | 85 | 98 | 134 | 161 | 206 |
| 120 | 59 | 64 | 75 | 102 | 123 | 157 |
| 140 | 40 | 44 | 51 | 69 | 83 | 106 |
| 160 | 33 | 36 | 42 | 57 | 68 | 87 |
| 180 | 25 | 28 | 32 | 44 | 53 | 67 |
| 200 | 23 | 25 | 29 | 40 | 48 | 62 |
| 240 | 22 | 24 | 28 | 38 | 46 | 58 |
| | Pressure | Pressure | Pressure | Pressure | Pressure | Pressure |
| Time - | for B = | for B = | for B = | for B = | for B = | for B = |
| Minutes | 18 | 19 | 20 | 21 | 22 | 23 |
| 0 | 377 | >400 | >400 | >400 | >400 | >400 |
| 30 | 372 | >400 | >400 | >400 | >400 | >400 |
| 60 | 350 | >400 | >400 | >400 | >400 | >400 |
| 80 | 334 | >400 | >400 | >400 | >400 | >400 |
| 100 | 295 | >400 | >400 | >400 | >400 | >400 |
| 120 | 225 | 335 | >400 | >400 | >400 | >400 |
| 140 | 153 | 227 | 341 | >400 | >400 | >400 |
| 160 | 125 | 187 | 280 | 397 | >400 | >400 |
| 180 | 96 | 144 | 215 | 305 | 366 | >400 |
| 200 | 88 | 132 | 197 | 280 | 336 | 395 |
| 240 | 83 | 124 | 187 | 264 | 317 | 373 |

33. The occupant support of claim 26 including a control schedule as set forth below and wherein the occupant specific parameter is risk category:

| | Pressure - mm Hg | | | | |
|---|---|---|---|---|---|
| | Very | | | Sub- | |
| Time - | High | High | Moderate | Moderate | Low |
| Minutes | Risk | Risk | Risk | Risk | Risk |
| 0 | 75 | 87 | 116 | 233 | >400 |
| 30 | 74 | 86 | 115 | 230 | >400 |
| 60 | 70 | 81 | 108 | 216 | >400 |
| 80 | 67 | 77 | 103 | 206 | >400 |
| 100 | 59 | 68 | 91 | 183 | >400 |
| 120 | 45 | 52 | 69 | 139 | >400 |
| 140 | 31 | 35 | 47 | 94 | 400 |
| 160 | 25 | 29 | 39 | 77 | 328 |
| 180 | 19 | 22 | 30 | 60 | 252 |
| 200 | 18 | 20 | 27 | 55 | 231 |
| 240 | 17 | 19 | 26 | 52 | 219 |

34. The method of claim 26 including a control schedule as set forth below and wherein the occupant specific parameter is weight:

| | Pressure - mm Hg | | | | | |
|---|---|---|---|---|---|---|
| | Weight Range (pounds) | | | | | |
| | 70-99 | 100-139 | 140-199 | 200-269 | 270-349 | 350-500 |
| Time | Weight Class | | | | | |
| (minutes) | A | B | C | D | E | F |
| 0 | 139 | 208 | 289 | 376 | 331 | 298 |
| 30 | 137 | 205 | 285 | 371 | 326 | 294 |
| 60 | 129 | 193 | 268 | 349 | 307 | 277 |
| 80 | 123 | 184 | 256 | 333 | 293 | 264 |
| 100 | 109 | 163 | 226 | 294 | 259 | 233 |
| 120 | 83 | 124 | 172 | 224 | 197 | 178 |
| 140 | 56 | 84 | 117 | 152 | 134 | 121 |
| 160 | 46 | 69 | 96 | 125 | 110 | 99 |
| 180 | 36 | 53 | 74 | 96 | 84 | 76 |
| 200 | 33 | 49 | 68 | 88 | 77 | 70 |
| ≧240 | 31 | 46 | 64 | 83 | 73 | 66 |
